(19) United States
(12) Patent Application Publication
(10) Pub. No.: US 2005/0244552 A1
(43) Pub. Date: Nov. 3, 2005

(54) Packaged meat product and packaging method for reducing purge in meat products

(75) Inventor: Eldon Roth, Dakota Dunes, SD (US)

Correspondence Address: Russell D. Culbertson;The Culbertson Group, P.C., Suite 420, 1114 Lost Creek Boulevard, Austin, TX, 78746, US

(73) Assignee: Freezing Machines, Inc.

(21) Appl. No.: 10/951,125

(22) Filed: Sep. 27, 2004

Related U.S. Application Data
(63) Continuation-in-part of application No. 10/835,426, filed on Apr. 29, 2004.

(51) Int. Cl. A23B 4/00

(52) U.S. Cl. 426/129

(57) ABSTRACT

A method for packaging meat products includes sealing a meat product in a container and maintaining a pressure on the meat product in the container at least one and one-half (1.5) pounds per square inch (psi) greater than atmospheric pressure. Pressures well above this minimum package pressure/atmospheric pressure differential of 1.5 psi may be employed. For example, pressures of ten (10) psi or more over atmospheric pressure may be used in a meat product container. One or more gasses may be released into the meat product container over time to help maintain the desired pressure on the meat product.

### CROSS-REFERENCE TO RELATED APPLICATION

This application is a continuation-in-part of U.S. patent application Ser. No. 10/835,426, filed Apr. 29, 2004, and entitled “Meat Product Package and Packaging Method with Maintained Atmosphere.” The Applicant claims the benefit of this earlier application under 35 U.S.C. §120, and the entire content of this earlier application is incorporated herein by this reference.

### TECHNICAL FIELD OF THE INVENTION

This invention relates to meat processing and meat packaging. More particularly, the invention relates to a meat packaging arrangement that reduces the purge of liquids from the meat. The invention also encompasses a method for packaging meat to reduce purge from the packaged meat.

### BACKGROUND OF THE INVENTION

It has become popular in recent years to process whole carcasses or carcass sections into smaller cuts or ground meat at a central processing facility, package the smaller cuts or ground meat, and then distribute the smaller cuts or ground meat to retailers and wholesalers in packaged form. Several different types of packages are used to distribute meat products in this distribution model. One type of commonly used package may be referred to as a tray-type package. A tray-type package includes a tray made from polystyrene or other suitable material. The meat product to be packaged is placed in the tray and then a sealing film material is sealed over a top opening of the tray to form a sealed container around the meat product. Another type of package commonly used for comminuted meats such as ground beef and sausage is referred to as a chub-type package. In chub packaging systems, the comminuted meat product is extruded into a tubular section of thin sheet material and then the sheet material is sealed around the product to form generally a cylindrical sealed container for the meat product.

Various gasses or mixtures of gasses in the package atmosphere surrounding a meat product may be used to help increase the shelf life of the packaged meat product. Packaging that controls the atmosphere surrounding the meat product is commonly referred to as modified atmosphere packaging or MAP. Carbon dioxide gas is an example of a gas commonly used in modified atmosphere packaging. Carbon dioxide gas has been used in modified atmosphere packaging in order to help maintain an anaerobic environment around the meat product and thereby inhibit the growth of aerobic microbes in the product. U.S. Pat. No. 5,352,467, for example, discloses a system in which a gas mixture including carbon dioxide gas is injected into a sealed package through a septum in the package.

One problem that arises in packaged meat products is the loss of liquids from the meat while the packaged meat product is in transit, in storage, or on display. The liquid lost from a meat product is commonly referred to as “purge.” In packaged meat products, the liquid or purge from the meat product collects in the package and may make the product less attractive to consumers.

### SUMMARY OF THE INVENTION

The present invention provides a packaging arrangement which maintains a desired pressure in the package. This desired pressure helps prevent or reduce purge from the packaged meat product. The invention encompasses a packaged meat product and a packaging method.

A method embodying the principles of the invention for packaging meat products includes sealing a meat product in a container and maintaining a pressure on the meat product in the container at least one and one-half (1.5) pounds per square inch (psi) greater than atmospheric pressure. Where the atmospheric pressure is 14.7 pounds per square inch absolute (psia), the minimum pressure maintained on the meat product in the container is 16.2 psia. Pressures well above this minimum package pressure/atmospheric pressure differential of 1.5 psi may be employed within the scope of the invention. For example, some preferred forms of the invention may maintain a pressure on the meat product in the sealed container that is ten (10) psi or more over atmospheric pressure.

It is noted that the term “meat product” is used throughout this disclosure and the accompanying claims to refer to meat alone, including lean portions, fat, and related materials of beef, pork, poultry, or seafood, and to refer to meat that has been mixed with, or includes, additives such as flavorings, extenders, fillers, tenderizing agents, and other materials. “Atmospheric pressure” is used in this disclosure and the accompanying claims to refer to the ambient pressure of the natural atmosphere surrounding the sealed container within which the meat product is sealed. It will also be noted that the temperature at which a package is maintained will commonly affect the relationship between the package pressure and the atmospheric pressure. The present invention encompasses maintaining at least the desired minimum package pressure of 1.5 psi over atmospheric pressure throughout the range of storage temperatures anticipated for the given meat product package.

The step of maintaining the desired pressure on the meat product above atmospheric pressure may include releasing a gas into the sealed container. One preferred form of the invention releases carbon dioxide gas into the sealed container. Carbon dioxide gas may be released from solid carbon dioxide held within the container or from a carbon dioxide gas impregnated plastic or other material held within the container. Where solid carbon dioxide provides the source for gas released into the container, the solid carbon dioxide may be held in an isolating container which prevents direct contact between the solid carbon dioxide and the meat product.

A packaged meat product according to the invention includes a sealed container with a meat product in an interior of the sealed container. The packaged meat product further includes an atmosphere in the interior of the sealed container at a pressure 1.5 psi or more greater than atmospheric pressure. Some preferred forms of the packaged meat product according to the invention further include a gas releasing object located within the interior of the sealed container. This gas releasing object releases one or more gasses into the sealed container to help maintain the desired pressure on the meat product in the container. A preferred gas releasing object comprises solid carbon dioxide placed loosely in the sealed container or held in an isolating container positioned within the container holding the meat product.

Maintaining pressure on a packaged meat product according to the present invention tends to reduce the amount of purge, that is, liquids, that are released from the meat product over time. In particular, maintaining pressure on the packaged meat product according to the invention helps reduce purge in meat products that have been injected with various fluids, commonly referred to as “brines.” By reducing purge in meat products, the present invention helps packaged meat products maintain a more desirable appearance to purchasers and potential purchasers.

These and other advantages and features of the invention will be apparent from the following description of the preferred embodiments, considered along with the accompanying drawings.

### BRIEF DESCRIPTION OF THE DRAWINGS

FIG. 1 is a view in perspective of a packaged meat product embodying the principles of the invention.

FIG. 2 is a view in section taken along line 2-2 in FIG. 1 and showing alternate locations for a carbon dioxide gas releasing material within the scope of the present invention.

FIG. 3 is a view in perspective of an isolating container embodying the principles of the present invention.

FIG. 4 is a view in section taken along line 4-4 in FIG. 3.

FIG. 5 is a diagrammatic representation of a packaging apparatus that may be used to produce a packaged meat product as shown in FIGS. 1 and 2.

FIG. 6 is a representation of a chub package embodying the principles of the invention.

### DESCRIPTION OF PREFERRED EMBODIMENTS

The claims at the end of this application set out novel features which the Applicant believes are characteristic of the invention. The various advantages and features of the invention together with preferred modes of use of the invention will best be understood by reference to the following description of illustrative embodiments read in conjunction with the drawings introduced above.

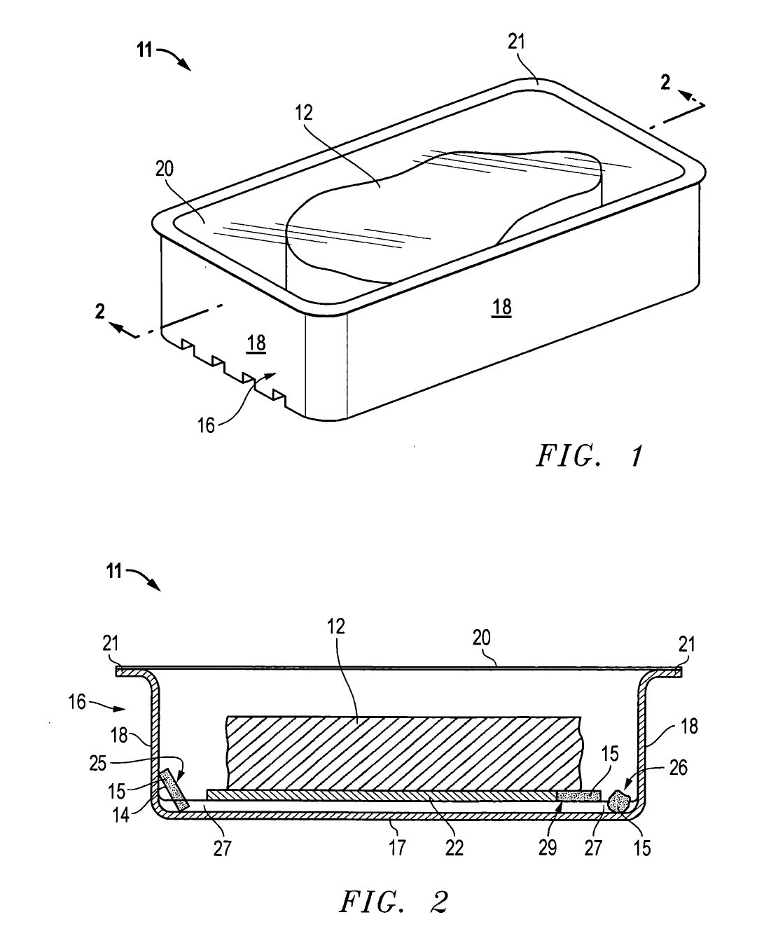

Referring first to FIGS. 1 and 2, a packaged meat product embodying the principles of the invention includes a sealed container 11 with a meat product 12 in an interior of the sealed container. As shown in FIG. 2, the illustrated preferred form of the invention includes a gas releasing object 15 included in sealed container 11 together with meat product 12. Other forms of the invention may rely on the initial gas pressure in container 11 to maintain the desired pressure in the container, while still other forms of the invention may rely on other arrangements for maintaining the desired pressures described below.

The example packaging arrangement for the packaged meat product shown in FIGS. 1 and 2 comprises a tray-type package. This tray-type package is made up of a tray 16 having a bottom 17, side walls 18, and a top or tray opening having a periphery defined by a surface 21 at the top of the tray. A sealing film 20 is sealed to surface 21 to isolate an interior of the container 11 from the external atmosphere, that is, the area outside of the sealed container. A package atmosphere surrounds meat product 12 within the interior of container 11. FIG. 2 shows meat product 12 resting on an absorbent pad material 22 which is adapted to absorb purge from the meat product.

Any suitable materials may be used in a tray-type package employed according to the present invention. Trays such as tray 16 are commonly produced from closed cell polystyrene. The tray material may be any other material that is generally impermeable to gasses and liquids. The sealing film may comprise a polyvinyl chloride (PVC) film or any other suitable film that is substantially impermeable to gasses and liquids.

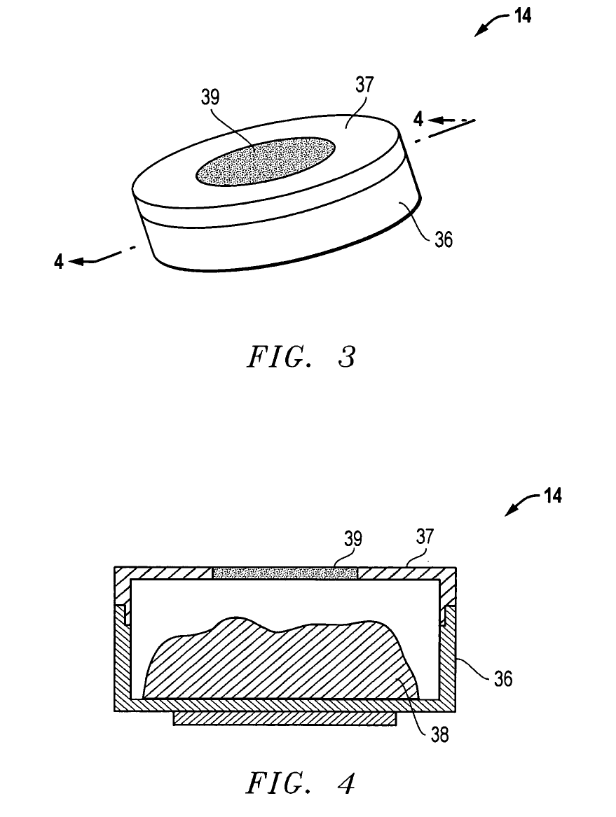

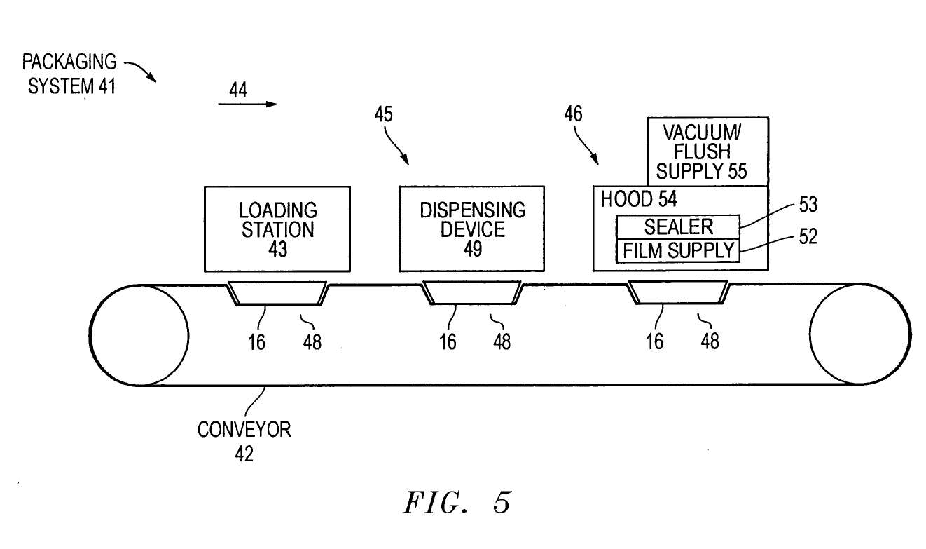

The gas releasing object 15 is shown at three alternate positions in sealed container 11 in FIG. 2. In a first position shown generally at reference numeral 25, gas releasing object 15 is shown in a suitable carrier or isolating container 14 resting at the bottom 17 of tray 16. Gas carriers and isolating containers will be described below with reference to FIGS. 3 and 4. In a second position 26 shown in FIG. 2, gas releasing object 15 rests loosely in a channel or indentation 27 formed in the bottom 17 of tray 16. Channel or indentation 27 may be formed in tray 16 specifically to hold the gas releasing material and allow the desired gas pressure in container 11 to reach the entire surface of meat product 12, or may be included to improve the rigidity and strength of the tray. The final alternate position for gas releasing object 15 shown in FIG. 2 is indicated generally at reference numeral 29. In this alternate position, the gas releasing object 15 is carried by or incorporated into absorbent pad 22.

Gas releasing object 15 within container 11 may comprise any material or combination of materials that is capable of releasing a suitable gas or multiple gasses into the atmosphere surrounding meat product 12. One preferred form of gas releasing object 15 comprises solid carbon dioxide which sublimes to release carbon dioxide gas into the package atmosphere surrounding meat product 12. Solid carbon dioxide may be contained loosely as one or more pellets, blocks, or flakes in sealed container 11 or may be contained in an isolating container such as the container 14 shown in FIG. 2, and described in greater detail below with reference to FIGS. 3 and 4. Where the gas releasing object comprises solid carbon dioxide, the solid carbon dioxide is preferably placed in sealed container 11 out of direct contact with meat product 12 to prevent the solid carbon dioxide from releasing to gas too rapidly. Alternatively to solid carbon dioxide, gas releasing object 15 may comprise a carrier material such as a suitable plastic or other material that is impregnated with one or more gasses, such as carbon dioxide gas for example.

Whether or not a gas releasing object is used in the present meat product container or package, such as container 11, the present invention includes maintaining a pressure on the meat product of at least 1.5 psi over atmospheric pressure. Where atmospheric pressure is 14.7 psia, the pressure on the meat product would have to be maintained at 16.2 psia. Particularly with meat products that have been treated with a pH increasing material such as an ammonia-based pH increasing material, it may be desirable to include some arrangement for releasing gas into the meat product container to help maintain the desired minimum pressure. Such gas releasing arrangements, such as gas releasing materials or objects sealed in the meat product container or an arrangement for injecting gas into the meat product container from a source outside the container, are, however, not required according to the present invention. Depending upon the nature of the gas atmosphere in the meat product container and the nature of the meat product, it may be possible to maintain the desired pressure over atmospheric pressure by sealing the container, such as container 11 shown in FIGS. 1 and 2, with a desired pressure already in place. Also, it may be desirable to use higher pressures on the packaged meat products, such as pressures of 10 psi or more above atmospheric pressure. Regardless of the specific pressure maintained over atmospheric pressure, a suitable pressure over atmospheric pressure is maintained on the packaged meat product over the entire temperature range at which the packaged meat product may be stored. The storage temperatures may range from approximately twenty-eight (28) degrees Fahrenheit to thirty-five 35 degrees Fahrenheit for most meat products.

The pressure that is maintained on the meat product according to the present invention is preferably applied as evenly as possible over all surfaces of the meat product. In order to prevent the pressure from being applied unevenly, the meat product, such as meat product 12 shown in FIGS. 1 and 2 is preferably supported on the bottom of the container 11 so that the pressure within the container reaches the lower surface of the meat product. This may be accomplished by supporting the meat product on a gas permeable pad such as absorbent pad 22 and/or by supporting the meat product on a structure on the bottom of the container that allows the gas pressure in the container to reach the lower surface of the meat product. A series of spaced apart channels or indentations formed in the container bottom itself (such as indentations 27 in FIG. 2) may provide the desired support structure for the meat product. Alternatively, a support structure separate from the container bottom may be used to allow the pressure in the container 11 to reach the lower surface of the meat product 12.

The present invention is not limited to any particular gas atmosphere in a meat product container such as container 11 shown in FIGS. 1 and 2. Rather, any suitable gas or mixture of gasses may be employed to provide a suitable environment for storing the meat product and for helping to maintain the desired pressure on the meat product. In particular, gasses such as nitrogen, helium, and argon, which are not significantly absorbed by the meat product, may be used either with or without other gasses such as carbon dioxide, oxygen, ammonia, and carbon 1 monoxide.

FIGS. 3 and 4 illustrate an isolating container 14 in which solid carbon dioxide, or perhaps other suitable gas releasing materials, or simply a gas or mixture of gasses may be contained, and then released slowly into another container such as container 11 shown in FIGS. 1 and 2. The primary function of isolating container 14 is to isolate the gas or gas releasing object from the meat products that are contained in the meat product container. Isolating container 14 may also help preserve the gas or gas releasing object and meter the release of gas into a meat product container such as container 11.

Isolating container 14 comprises an enclosure having a base section 36 and a lid section 37, both made of a suitable material such as a suitable plastic. Base section 36 and lid section 37 are adapted to connect together with a frictional or other suitable engagement to form an enclosed area in which a supply of gas or a gas releasing object or material 38 may be contained. Lid section 37 has associated with it a gas permeable wall or boundary 39. This gas permeable wall or boundary 39 allows the gas or gasses, such as a gas released from material 38, to exit isolating container 14 and enter the atmosphere surrounding the meat product in a sealed container, such as container 11 in FIGS. 1 and 2 for example. The gas permeable wall or boundary 39 may include one or more small openings which allow gas to escape from isolating container 14. Alternatively, gas permeable wall or boundary 39 may include or be made from a material that is permeable to gas without discrete openings. The permeability to the respective gas or gasses associated with wall or boundary 39 may be selected to allow gas to meter slowly from the isolating container 14. This gas metering arrangement may allow the supply of gas or gas releasing material to last for an extended period of time.

It will be appreciated that the isolating container 14 shown in FIGS. 3 and 4 is shown only for purposes of example and that may other types of containers may be used to contain solid carbon dioxide or other materials making up the gas releasing object, or simply a gas or gas mixture. For example, solid carbon dioxide may be contained between two layers of material which are sealed around their periphery to form a pouch. Also, it should be noted again that it may be unnecessary to place the gas releasing object or material in an isolating container. Rather, the gas releasing object or material may simply be placed loosely in a container such as container 11 shown in FIGS. 1 and 2. An isolating container such as container 14 or other suitable container will be required to contain a gas or gas mixture that is to be released to maintain a desired package pressure according to the invention. Where a container such as container 14 is used to hold a supply of gas under a suitable pressure for release into the meat package or container, the pressurized gas container itself may be considered a gas releasing object within the scope of the present invention.

FIG. 5 provides a diagrammatic representation of a packaging system 41 that may be employed to produce a packaged meat product according to the invention where a tray-type package such as that shown in FIGS. 1 and 2 provides a sealing enclosure for the meat product and any gas releasing object. Packaging system 41 includes a conveyor 42 adapted to receive an open or unsealed meat product tray (such as tray 16 shown in FIGS. 1 and 2 forming a part of a sealing enclosure) at a loading station 43, and then move the tray 16 in a machine direction 44 through a dispensing station shown generally at reference numeral 45 and a sealing station shown generally at reference numeral 46. Conveyor 42 includes a number of tray carriers each having at least one tray receptacle 48 adapted to receive a tray 16. Dispensing station 45 includes a suitable dispensing device 49 for dispensing a suitable gas releasing object or material (not shown in FIG. 5) into a tray 16 at the dispensing station. The illustrated sealing station 46 includes a sealing arrangement made up of a sealing film positioning and supply device 52 and sealing device 53. Sealing station 46 further includes a vacuum/flushing arrangement made up of vacuum/flush hood 54 and a vacuum/flushing material supply 55.

In operation of the packaging system 41 shown in FIG. 5, a tray 16 containing the desired meat product (not shown in FIG. 5) is loaded into a respective receptacle 48 at loading station 43. This may be accomplished in any suitable manner within the scope of the invention. In one preferred form, tray 16 is first loaded empty or containing only an absorbent pad and then the meat product is deposited into the tray. Alternatively, tray 16 may be loaded with an absorbent pad and then the meat product, after which the tray may be loaded into a receptacle 48. Once the meat product bearing tray 16 is loaded in a receptacle 48, conveyor 42 moves the tray to dispensing station 45 where dispensing device 49 dispenses a gas releasing object (such as isolating container 14 or a desired amount of gas releasing material) into the tray with the meat product. Dispensing device 49 may comprise a device for dispensing a desired quantity of solid carbon dioxide in the form of flakes or pellets. In forms of the invention using an isolating container such as container 14 described in FIGS. 3 and 4, or a carbon dioxide impregnated object, dispensing device 49 may comprise a device for dropping one or more of the containers or objects into the tray 16 at the dispensing station. In any event, once tray 16 contains the meat product and the gas releasing material, conveyor 42 moves the tray to the sealing station 46 to be sealed. The illustrated packaging system 41 first lowers hood 54 to form a chamber around the tray 16 and then applies a vacuum and/or supplies flushing gas from vacuum/flushing gas supply 55. Once the vacuum and/or flush has been applied, sealing film supply places a sealing film over the top opening of the tray 16 and sealing device 53 (such as a heated platen) seals the film around the periphery of the tray top opening. The conveyor 42 may then advance the resulting packaged meat product on to a suitable discharge arrangement (not shown) to discharge the packaged product from packaging system 41.

It will be appreciated that the invention is by no means limited to the illustrative packaging system 41 shown in FIG. 5. Many variations are possible within the scope of the present invention. Numerous types of conveyor devices, tray loading devices, dispensing devices, tray sealing devices, and vacuum/flush devices may be used within the scope of the present invention. The sequence of steps may also be varied within the scope of the invention. For example, dispensing device 49 may be adapted to dispense a gas releasing object or gas releasing material into a tray 16 prior to the meat product being loaded into the tray. Also, the device for dispensing the gas releasing object or material may be incorporated into the sealing station 46 shown in FIG. 5.

Alternatively to releasing or adding gas into the sealed container (such as container 11 in FIGS. 1 and 2), the initial atmosphere created in the package may be used to maintain the desired pressure. For example, a packaging system similar to system 41 shown in FIG. 5 may dispense with the dispensing station 45 and dispensing device 49, and use sealing station 46 to create the desired atmosphere and pressure in the meat product container. In this alternative packaging arrangement, the sealing station would create the desired gas atmosphere in the open container at the desired pressure, and then, while maintaining that pressure, apply the sealing film to seal in atmosphere under the desired pressure. This process of applying the sealing film to the container after producing the desired pressure in the container may be performed even where a gas releasing object or material is used within the package to help maintain the desired pressure.

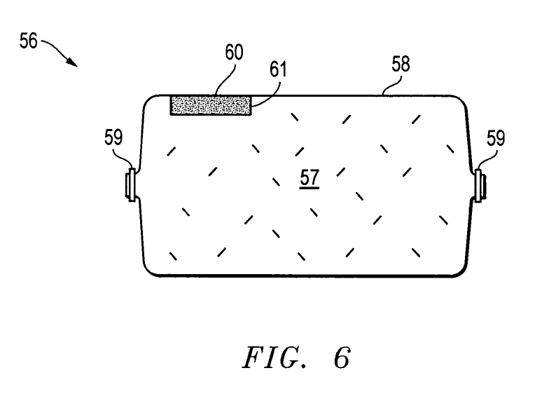

FIG. 6 shows an alternate meat package and packaged meat product 56 within scope of the present invention. This form of the invention uses a chub-type package containing a quantity of comminuted meat product 57 such as ground beef or sausage. The chub package is formed from a thin sheet of packaging material 58 such as a suitable plastic which is formed into a tube shape and then sealed or tied at each end with a suitable tying device 59 to seal in the comminuted meat product 57. According to one preferred form of the present invention, a gas releasing object 60 is included within the area defined by packaging material 58 in position to release gas into the interior of the package. The gas releasing object 60 may comprise loose material such as solid carbon dioxide loose in the area defined by packaging material 58. Alternatively, gas releasing object or material 60 may be contained in a container 61 similar to container 14 described above with reference to FIGS. 3 and 4, or some other suitable container. The container 61 is also preferably adhered or attached to the inside surface of the packaging material 58.

It will be appreciated that the two types of packages shown in the figures, the tray-type package 11 shown in FIGS. 1 and 2, and the chub-type package 56 shown in FIG. 6 are merely examples of the packages with which the present invention may be employed. Generally, the package requires only at least one package material that is formed around a meat product to seal in the meat product and prevent liquids and gasses from escaping from the package. There are numerous variations within the two general types of packages described above in reference to the figures. For example, a tray-type package may include a tray having lower side walls so that the sealing film that provides a seal around the periphery of the tray actually makes contact with the meat product resting on the tray.

The present invention has application to substantially any type of meat product. However, the invention has particular application to meat products that have been treated with a pH increasing material such as an ammonia-based pH increasing material, either alone or with oxygen or other materials. The invention also has particular application to meat products that have been treated with carbon monoxide, either alone or with pH increasing materials. Although not limited to these processes, meat products packaged according to the present invention may be treated with a pH increasing material as described in U.S. Pat. No. 6,142,067, or as described in pending U.S. patent application Ser. No. 10/379,761, filed Mar. 5, 2003. Meat products packaged according to the present invention may be treated with carbon monoxide in any suitable process, particularly the process disclosed in pending U.S. patent application Ser. No. 10/795,000, filed Mar. 5, 2004. The entire content of U.S. Pat. No. 6,142,067 is incorporated herein by this reference as is the entire content of patent application Ser. No. 10/379,761 and application Ser. No. 10/795,000.

The above described preferred embodiments are intended to illustrate the principles of the invention, but not to limit the scope of the invention. Various other embodiments and modifications to these preferred embodiments may be made by those skilled in the art without departing from the scope of the present invention.

1. A packaged meat product including:
(a) a sealed container;
(b) a meat product in an interior of the sealed container; and
(c) an atmosphere in the interior of the sealed container at a pressure of at least 1.5 psi greater than atmospheric pressure.

2. The packaged meat product of claim 1 wherein the pressure in the interior of the sealed container is at least 16.2 psia.

3. The packaged meat product of claim 1 wherein the pressure in the interior of the sealed container is 10 or more psi over atmospheric pressure.

4. The packaged meat product of claim 1 further including a gas releasing object located within the interior of the sealed container.

5. The packaged meat product of claim 4 wherein the gas releasing object includes solid carbon dioxide.

6. The packaged meat product of claim 5 wherein the solid carbon dioxide is contained within the sealed container in a carrier device having at least one carbon dioxide gas permeable boundary.

7. The packaged meat product of claim 4 wherein the gas releasing object comprises a carrier material impregnated with carbon dioxide gas.

8. The packaged meat product of claim 1 wherein the meat product comprises a meat product that has been treated with a pH increasing material.

9. The packaged meat product of claim 8 wherein the pH increasing material comprises an ammonia based pH increasing material.

10. A method for packaging meat products, the method including:
(a) sealing a meat product in a container; and
(b) maintaining a pressure on the meat product in the container at least 1.5 psi greater than atmospheric pressure.

11. The method of claim 10 wherein the pressure maintained on the meat product in the container is 10 psi or more greater than atmospheric pressure.

12. The method of claim 10 wherein the maintaining the pressure on the meat product in the container is accomplished by maintaining a gas atmosphere in the container of at least 16.2 psia.

13. The method of claim 10 wherein maintaining the pressure on the meat product in the container includes releasing a gas into the container after sealing the container.

14. The method of claim 13 wherein the gas is released into the container from a gas releasing object in the container separate from the meat product.

15. The method of claim 14 wherein the gas releasing object comprises solid carbon dioxide.

16. The method of claim 15 further including the step of containing the solid carbon dioxide in an isolating container held inside the container.

17. The method of claim 14 wherein the gas releasing object comprises a material that has been impregnated with carbon dioxide.

18. The method of claim 10 further including the step of applying a pH increasing material to the meat product either before or after sealing the meat product in the container.

19. The method of claim 10 wherein the step of sealing the meat product in the container includes placing the meat product in a tray of a tray-type package and then sealing a film material over an opening of the tray to enclose an atmosphere in the container at least 1.5 psi greater than atmospheric pressure.

20. The method of claim 10 wherein the step of sealing the meat product in the container includes sealing the meat product in a chub package.
